(19) United States
(12) Patent Application Publication
(10) Pub. No.: US 2020/0310799 A1
(43) Pub. Date: Oct. 1, 2020

(54) Compiler-Allocated Special Registers That Resolve Data Hazards With Reduced Hardware Complexity

(71) Applicant: MediaTek Inc., Hsinchu City (TW)

(72) Inventors: Wei-Che Hsu, Taipei City (TW); Chia-Chi Chang, Hsinchu County (TW); Chia-Hsien Chou, Hsinchu County (TW)

(21) Appl. No.: 16/365,674

(22) Filed: Mar. 27, 2019

(51) Int. Cl. G06F 9/30

(52) U.S. Cl. CPC G06F 9/30101; G06F 9/3001; G06F 9/30141

(57) ABSTRACT

Various examples with respect to compiler-allocated special registers that resolve data hazards with reduced hardware complexity are described. A processor includes a plurality of hardware components arranged in in an instruction set architecture. The processor allocates one or more forwarding registers with respect to the execution of an instruction. The processor also performs arithmetic operations based on the instruction with data input from multiple ways of the instruction set architecture such that the one or more forwarding registers is utilized for data forwarding between the multiple ways of the instruction set architecture.

### TECHNICAL FIELD

The present disclosure is generally related to computer architecture and, more particularly, to compiler-allocated special registers that resolve data hazards with reduced hardware complexity.

### BACKGROUND

Unless otherwise indicated herein, approaches described in this section are not prior art to the claims listed below and are not admitted as prior art by inclusion in this section.

In computing systems, instruction pipelining is a technique used in computer architecture for implementing instruction-level parallelism within a single processor. Incoming instructions may be divided into a series of sequential steps performed by different functional units. In pipelining, a data hazard can occur when an instruction attempts to use data before such data is available in a register file, and data hazards can lead to a pipeline stall when a current operation needs to wait for result(s) of an earlier operation which has not yet finished. Thus, operand forward (or data forwarding) is a technique used to avoid or minimize pipeline stalls. In existing designs, hardware supported forwarding for a given functional unit tends to involve complex multiplexor (MUX) design with numerous MUXs and comparator(s), yet complex MUX design tends to lead to power leakage. The hardware is required to perform a number of conditions including, for example, checking whether forwarding results have been written to the pipeline, comparing and deciding which operand should use a forwarding result, and determining from which stage of the pipeline a forwarding result comes. In architectures designed for very long instruction word (VLIW), hardware support of forwarding for multiple functional units is necessary. In such cases, the MUX design is even more complex and there tends to be more power leakage. Moreover, in VLIW processors, instructions are usually scheduled by a compiler. In some cases, each instruction can be 32 bits long with 3 bits dedicated for forwarding information.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

Proposed schemes in accordance with the present disclosure pertain to compiler-allocated special registers that resolve data hazards with reduced hardware complexity. Under the proposed schemes, data forwarding may be supported by compiler with less hardware complexity relative to conventional designs. Additionally, the proposed schemes utilize special registers to deliver forwarding information from different ways (slots) in a VLIW architecture.

In one aspect, a method may involve a processor of an apparatus allocating one or more forwarding registers with respect to the execution of an instruction. The method may also involve the processor performing arithmetic operations based on the instruction with data input from multiple ways of an instruction set architecture such that the one or more forwarding registers is utilized for data forwarding between the multiple ways of the instruction set architecture.

In another aspect, an apparatus may include a processor. The processor may include a plurality of hardware components arranged in an instruction set architecture. The processor may be capable of allocating one or more forwarding registers with respect to the execution of an instruction. The processor may also be capable of performing arithmetic operations based on the instruction with data input from multiple ways of the instruction set architecture such that the one or more forwarding registers is utilized for data forwarding between the multiple ways of the instruction set architecture.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example special register allocation with which a proposed scheme in accordance with the present disclosure may be implemented.

FIG. 2 is a diagram of an example scenario in accordance with an implementation of the present disclosure.

FIG. 3A and FIG. 3B are each an example scenario in accordance with an implementation of the present disclosure.

FIG. 4A-FIG. 4K are each an example scenario in accordance with an implementation of the present disclosure.

FIG. 5 is a diagram of an example apparatus in accordance with an implementation of the present disclosure.

FIG. 6 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to compiler-allocated special registers that resolve data hazards with reduced hardware complexity. According to the present disclosure, a number of possible solutions may be implemented separately or jointly. That is, although these possible solutions may be described below separately, two or more of these possible solutions may be implemented in one combination or another.

Under a proposed scheme in accordance with the present disclosure, compiler-allocated special registers may be utilized to resolve data hazards with reduced hardware design complexity. Under the proposed scheme, forwarding information may be delivered to hardware through special registers from different ways (slots) of a VLIW architecture. Advantageously, the proposed scheme may resolve data hazards between different ways (slots) of the VLIW architecture without the use of extra encoding bit fields. Under the proposed scheme, there is no need to write back to a register file when the value of a register lives only lives within two stages of pipelining. Advantageously, the proposed scheme may lead to lower register pressure without power leakage in accessing the register file. Moreover, the proposed scheme may reduce complexity in hardware design, including the complexity of MUX design, and there may be no need to compare operands with forwarding results. Furthermore, the proposed scheme may reduce power leakage.

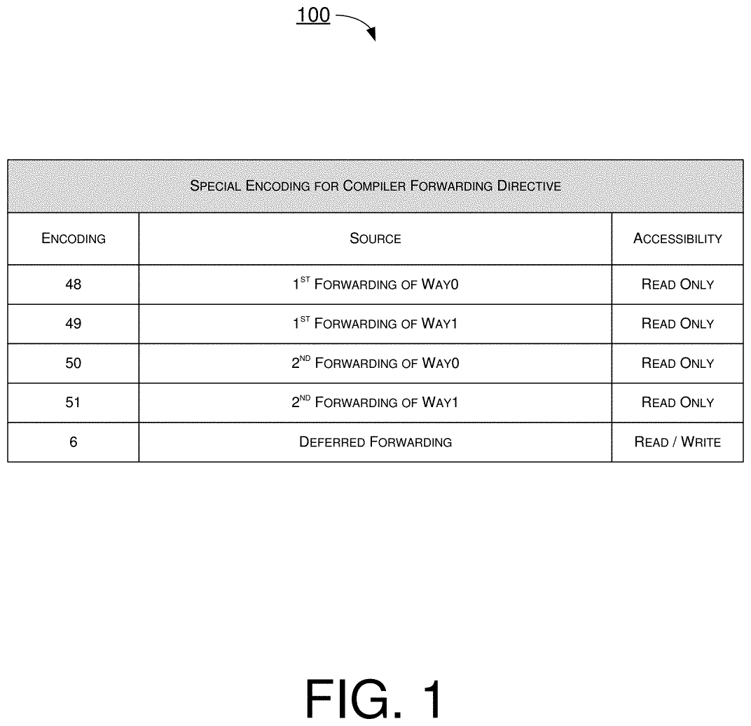

FIG. 1 illustrates an example special register allocation 100 with which a proposed scheme in accordance with the present disclosure may be implemented. Under a proposed scheme in accordance with the present disclosure, one or more special registers (herein interchangeably referred to as “forwarding registers”) may be allocated by a compiler during compile time for the purpose of delivering forwarding information. Advantageously, the allocation and utilization of special registers in accordance with the present disclosure may reduce hardware design complexity and resolve the issue with data hazards.

Referring to FIG. 1, in the example shown, a first special register may be encoded or otherwise denoted as “48” for first forwarding of a first way or slot (e.g., way 0) of the VLIW architecture, and the accessibility of which may be “read only.” Additionally, a second special register may be encoded or otherwise denoted as “49” for first forwarding of a second way or slot (e.g., way 1) of the VLIW architecture, and the accessibility of which may be “read only.” Moreover, a third special register may be encoded or otherwise denoted as “50” for second forwarding of the first way or slot (e.g., way 0) of the VLIW architecture, and the accessibility of which may be “read only.” Furthermore, a fourth special register may be encoded or otherwise denoted as “51” for second forwarding of the second way or slot (e.g., way 1) of the VLIW architecture, and the accessibility of which may be “read only.” Also, a fifth special register may be encoded or otherwise denoted as “6” for deferred forwarding, and the accessibility of which may be “read and write.”

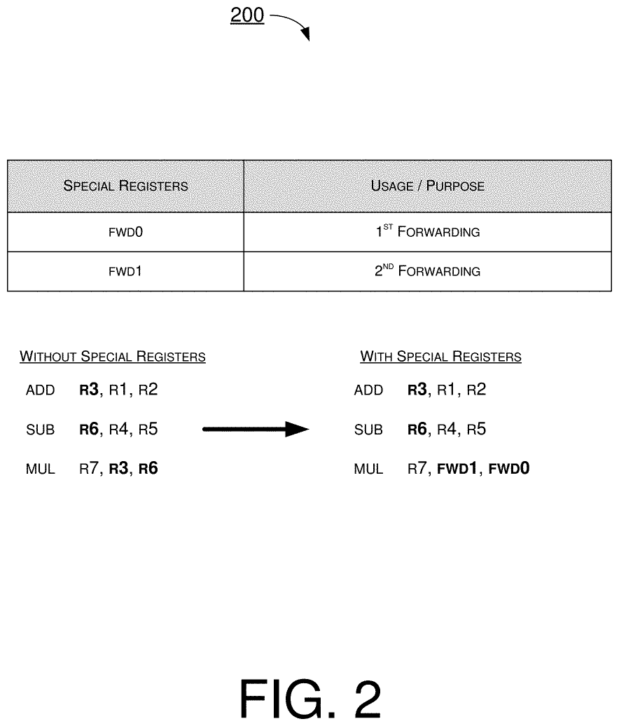

FIG. 2 illustrates an example scenario 200 in accordance with an implementation of the present disclosure. In scenario 200, a first special register may be encoded or otherwise denoted as “fwd0” for first forwarding, and a second special register may be encoded or otherwise denoted as “fwd1” for second forwarding. Scenario 200 may involve some arithmetic operations such as addition, subtraction and multiplication.

Referring to FIG. 2, without allocation and utilization of special registers, a first arithmetic operation may involve adding a value stored in register r1 and a value stored in register r2 to provide a result, the value of which is stored in register r3. Also, a second arithmetic operation may involve subtracting a value stored in register r4 from a value stored in register r5 to provide a result, the value of which is stored in register r6. Then, a third arithmetic operation may involve multiplying the value stored in register r3 and the value stored in register r6 to provide a result, the value of which is stored in register r7.

With allocation and utilization of special registers (e.g., fwd0 and fwd1) in accordance with the present disclosure, special register fwd0 may be allocated for forwarding the value of the second arithmetic operation (namely, addition of values stored in registers r1 and r2) and special register fwd1 may be allocated for forwarding the value of the first arithmetic operation (namely, subtraction between values stored in registers r4 and r5). Accordingly, the third arithmetic operation may be performed using the forwarded values without the need of writing the value of the first arithmetic operation or the value of the second arithmetic operation to a next stage.

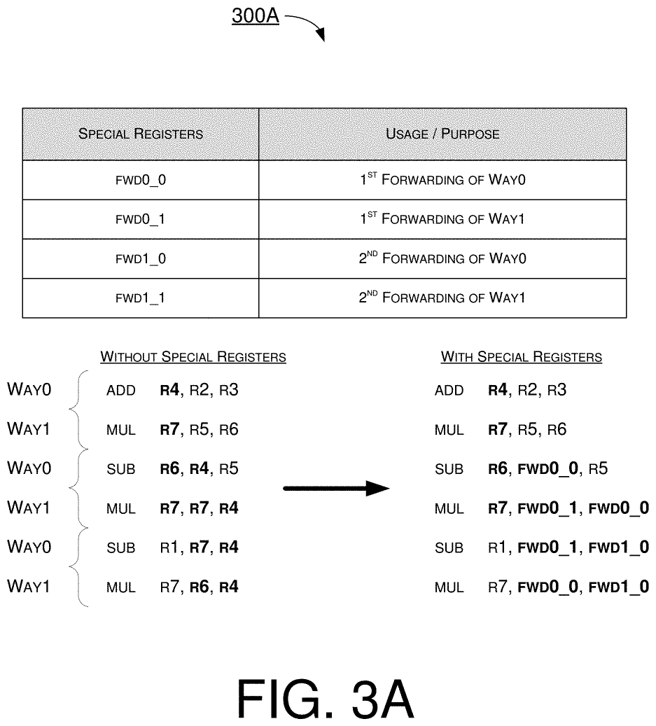

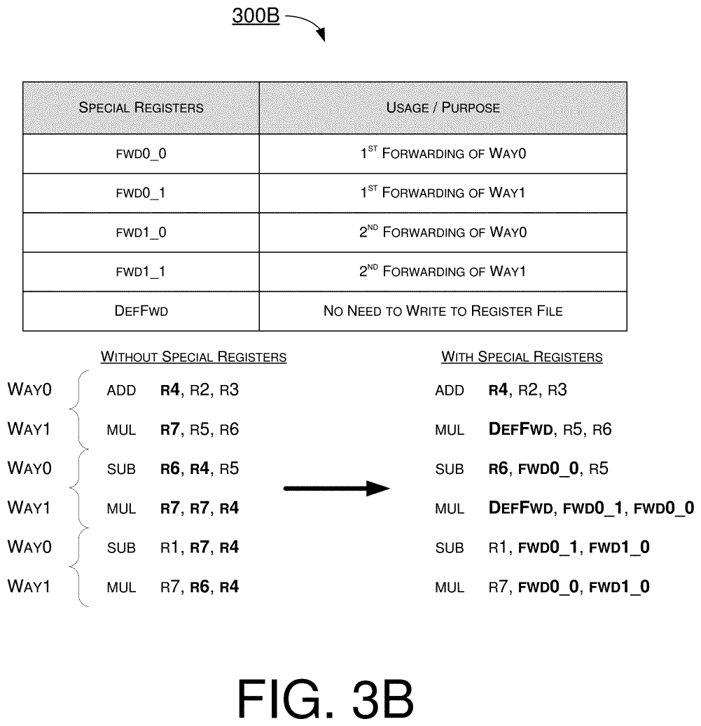

FIG. 3A illustrates an example scenario 300A in accordance with an implementation of the present disclosure. In scenario 300A, a first special register may be encoded or otherwise denoted as “fwd0_0” for first forwarding of a first way (e.g., way 0), a second special register may be encoded or otherwise denoted as “fwd0_1” for first forwarding of a second way (e.g., way 1), a third special register may be encoded or otherwise denoted as “fwd1_0” for second forwarding of the first way, and a fourth special register may be encoded or otherwise denoted as “fwd1_1” for second forwarding of the second way. Scenario 300A may involve some arithmetic operations such as addition, subtraction and multiplication.

Referring to FIG. 3A, without allocation and utilization of special registers, a first arithmetic operation in way 0 may involve adding a value stored in register r2 and a value stored in register r3 to provide a result, the value of which is stored in register r4. Also, a second arithmetic operation in way 1 may involve multiplying a value stored in register r5 and a value stored in register r6 to provide a result, the value of which is stored in register r7. Then, a third arithmetic operation in way 0 may involve subtracting the value stored in register r4 from the value stored in register r5 to provide a result, the value of which is stored in register r6. Additionally, a fourth arithmetic operation in way 1 may involve multiplying the value stored in register r7 and the value stored in register r4 to provide a result, the value of which is stored in register r7. Moreover, a fifth arithmetic operation in way 0 may involve subtracting the value stored in register r7 from the value stored in register r4 to provide a result, the value of which is stored in register r1. Furthermore, a sixth arithmetic operation in way 1 may involve multiplying the value stored in register r6 and the value stored in register r4 to provide a result, the value of which is stored in register r7.

With allocation and utilization of special registers (e.g., fwd0_0, fwd0_1, fwd1_0 and fwd1_1) in accordance with the present disclosure, the first arithmetic operation in way 0 may involve adding a value stored in register r2 and a value stored in register r3 to provide a result, the value of which is stored in special register fwd0_0 when it goes to execution stage of pipeline then stored in register r4 when it goes to write-back stage of the pipeline if necessary (e.g., in an event that the destination register is not DefFwd register). Also, the second arithmetic operation in way 1 may involve multiplying a value stored in register r5 and a value stored in register r6 to provide a result, the value of which is stored in special register fwd0_1 when it goes to execution stage of pipeline then stored in register r7 when it goes to write-back stage of the pipeline if necessary. Then, the third arithmetic operation in way 0 may involve subtracting the value forwarded by special register fwd0_0 from the value stored in register r5 to provide a result, the value of which is stored in special register fwd0_0 when it goes to execution stage of pipeline then stored in register r6 when it goes to write-back stage of the pipeline if necessary (e.g., in an event that the destination register is not DefFwd register). Additionally, the fourth arithmetic operation in way 1 may involve multiplying the value forwarded by special register fwd0_1 and the value forwarded by special register fwd0_0 to provide a result, the value of which is stored in special register fwd0_1 when it goes to execution stage of pipeline then stored in register r7 when it goes to write-back stage of the pipeline if necessary. Moreover, the fifth arithmetic operation in way 0 may involve subtracting the value forwarded by special register fwd0_1 from the value forwarded by special register fwd1_0 to provide a result, the value of which is stored in register r1. Furthermore, a sixth arithmetic operation in way 1 may involve multiplying the value forwarded by special register fwd0_0 and the value forwarded by special register fwd1_0 to provide a result, the value of which is stored in register r7.

FIG. 3B illustrates an example scenario 300B in accordance with an implementation of the present disclosure. In scenario 300B, a first special register may be encoded or otherwise denoted as “fwd0_0” for first forwarding of a first way (e.g., way 0), a second special register may be encoded or otherwise denoted as “fwd0_1” for first forwarding of a second way (e.g., way 1), a third special register may be encoded or otherwise denoted as “fwd1_0” for second forwarding of the first way, a fourth special register may be encoded or otherwise denoted as “fwd1_1” for second forwarding of the second way, and a fifth special register may be encoded or otherwise denoted as “DefFwd” to eliminate a need to write to a register file. Scenario 300B may involve some arithmetic operations such as addition, subtraction and multiplication.

Referring to FIG. 3B, without allocation and utilization of special registers, a first arithmetic operation in way 0 may involve adding a value stored in register r2 and a value stored in register r3 to provide a result, the value of which is stored in register r4. Also, a second arithmetic operation in way 1 may involve multiplying a value stored in register r5 and a value stored in register r6 to provide a result, the value of which is stored in register r7. Then, a third arithmetic operation in way 0 may involve subtracting the value stored in register r4 from the value stored in register r5 to provide a result, the value of which is stored in register r6. Additionally, a fourth arithmetic operation in way 1 may involve multiplying the value stored in register r7 and the value stored in register r4 to provide a result, the value of which is stored in register r7. Moreover, a fifth arithmetic operation in way 0 may involve subtracting the value stored in register r7 from the value stored in register r4 to provide a result, the value of which is stored in register r1. Furthermore, a sixth arithmetic operation in way 1 may involve multiplying the value stored in register r6 and the value stored in register r4 to provide a result, the value of which is stored in register r7.

With allocation and utilization of special registers (e.g., fwd0_0, fwd0_1, fwd1_0, fwd1_1 and DefFwd) in accordance with the present disclosure, the first arithmetic operation in way 0 may involve adding a value stored in register r2 and a value stored in register r3 to provide a result, the value of which is stored in special register fwd0_0 when it goes to execution stage of pipeline then stored in register r4 when it goes to write-back stage of the pipeline if necessary (e.g., in an event that the destination register is not DefFwd register). Also, the second arithmetic operation in way 1 may involve multiplying a value stored in register r5 and a value stored in register r6 to provide a result, the value of which is stored in special register fwd0_1 when it goes to execution stage of pipeline then stored in register r7 when it goes to write-back stage of the pipeline because it is marked as DefFwd register. Then, the third arithmetic operation in way 0 may involve subtracting the value forwarded by special register fwd0_0 from the value stored in register r5 to provide a result, the value of which is stored in special register fwd0_0 when it goes to execution stage of pipeline then stored in register r6 when it goes to write-back stage of the pipeline if necessary (e.g., in an event that the destination register is not DefFwd register). Additionally, the fourth arithmetic operation in way 1 may involve multiplying the value forwarded by special register fwd0_1 and the value forwarded by special register fwd0_0 to provide a result, the value of which is stored in special register fwd0_1 when it goes to execution stage of pipeline then stored in register r7 when it goes to write-back stage of the pipeline because it is marked as DefFwd register. Moreover, the fifth arithmetic operation in way 0 may involve subtracting the value forwarded by special register fwd0_1 from the value forwarded by special register fwd1_0 to provide a result, the value of which is stored in register r1. Furthermore, a sixth arithmetic operation in way 1 may involve multiplying the value forwarded by special register fwd0_0 and the value forwarded by special register fwd1_0 to provide a result, the value of which is stored in register r7.

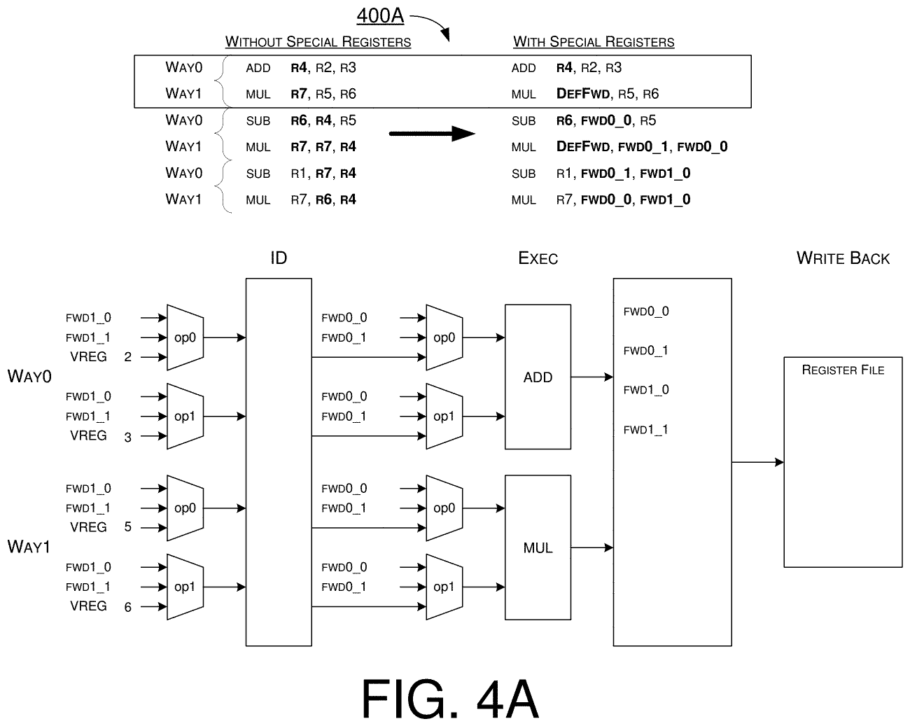

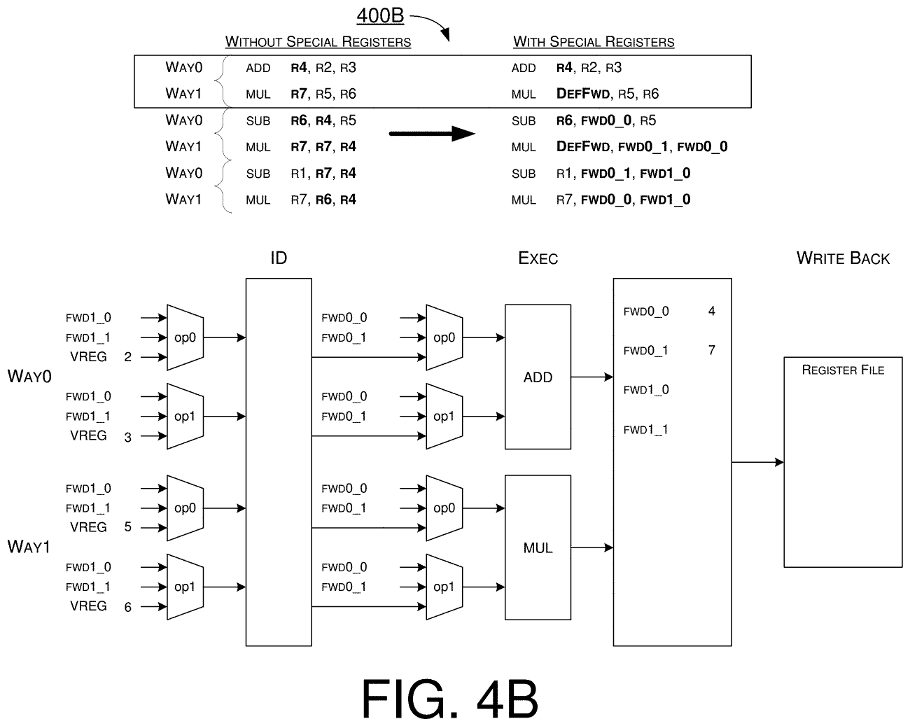

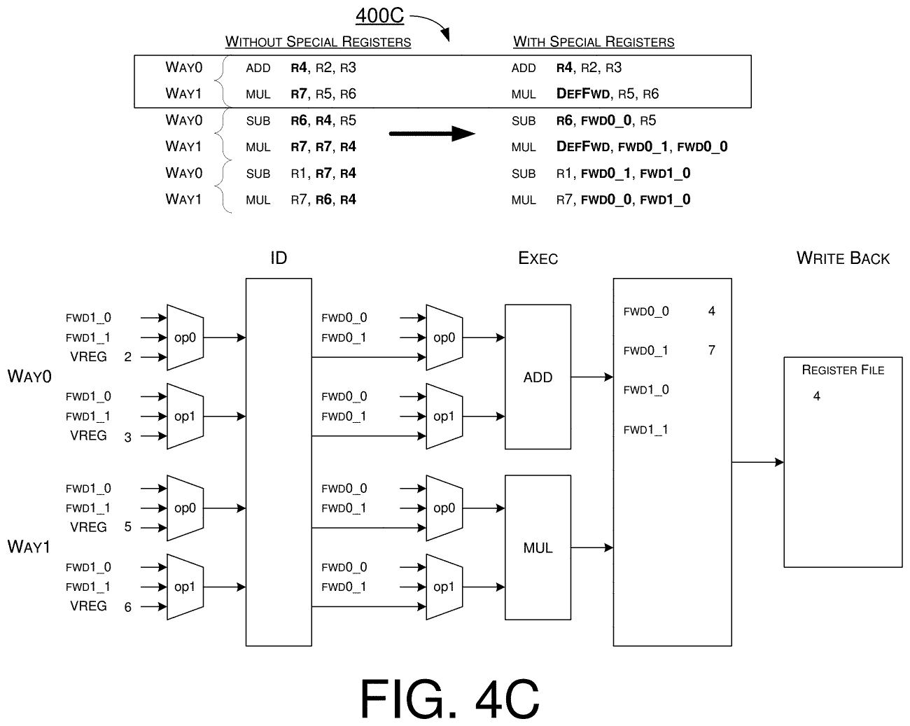

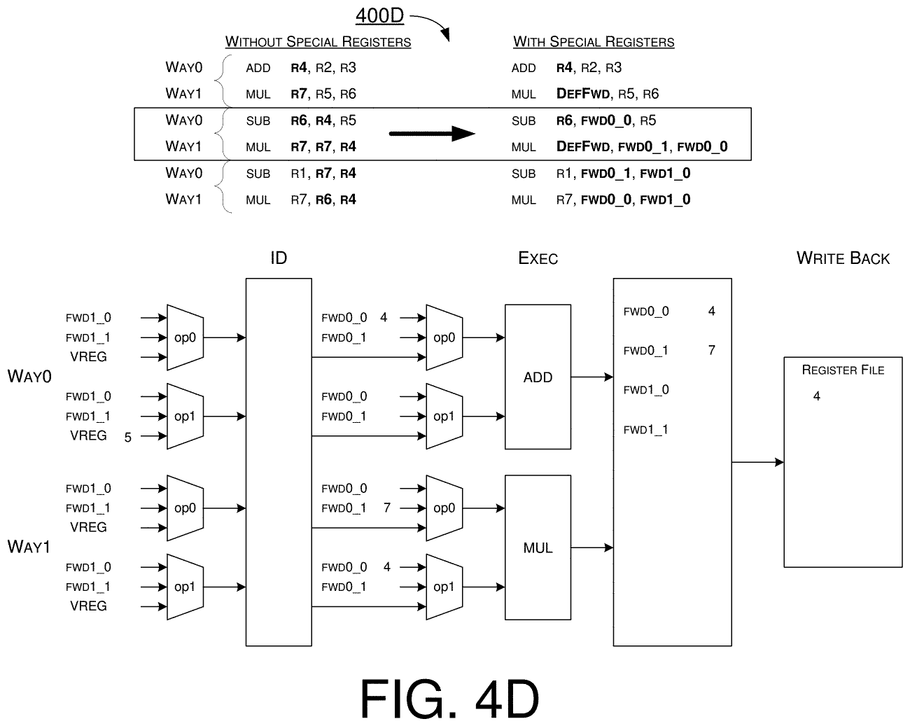

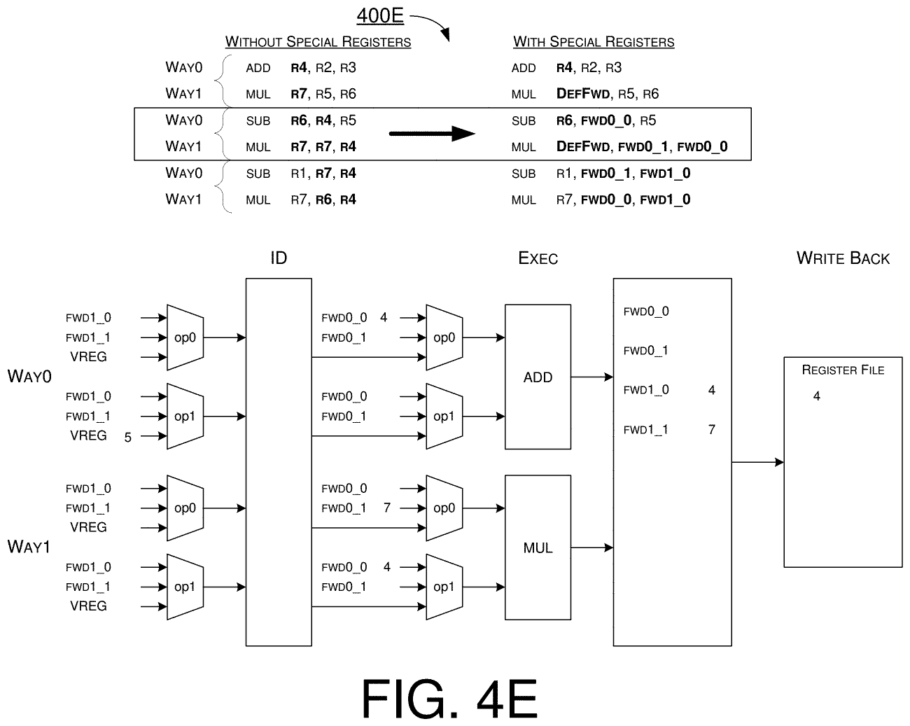

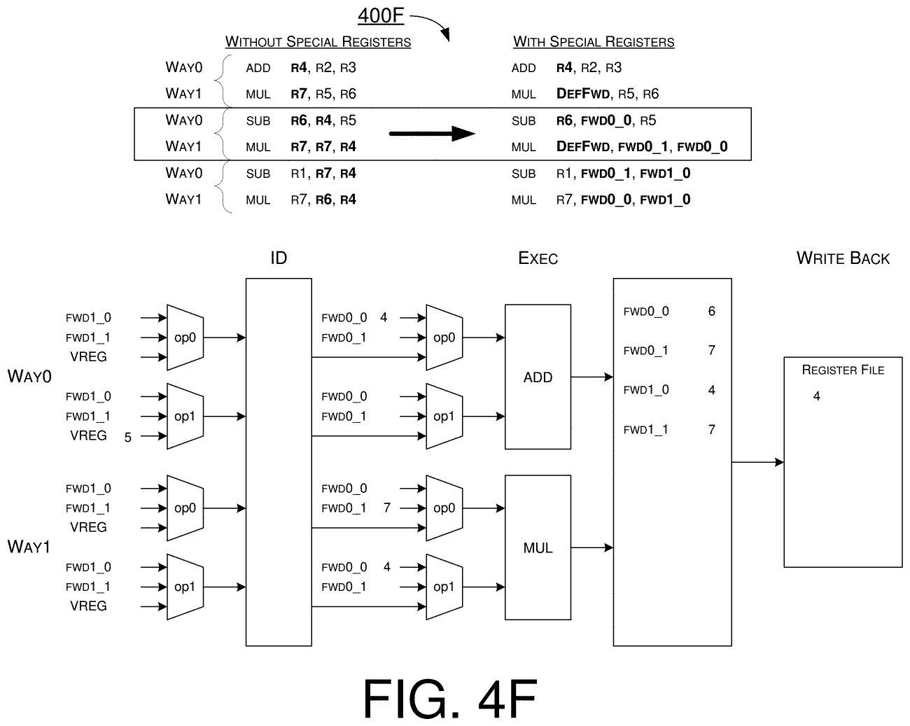

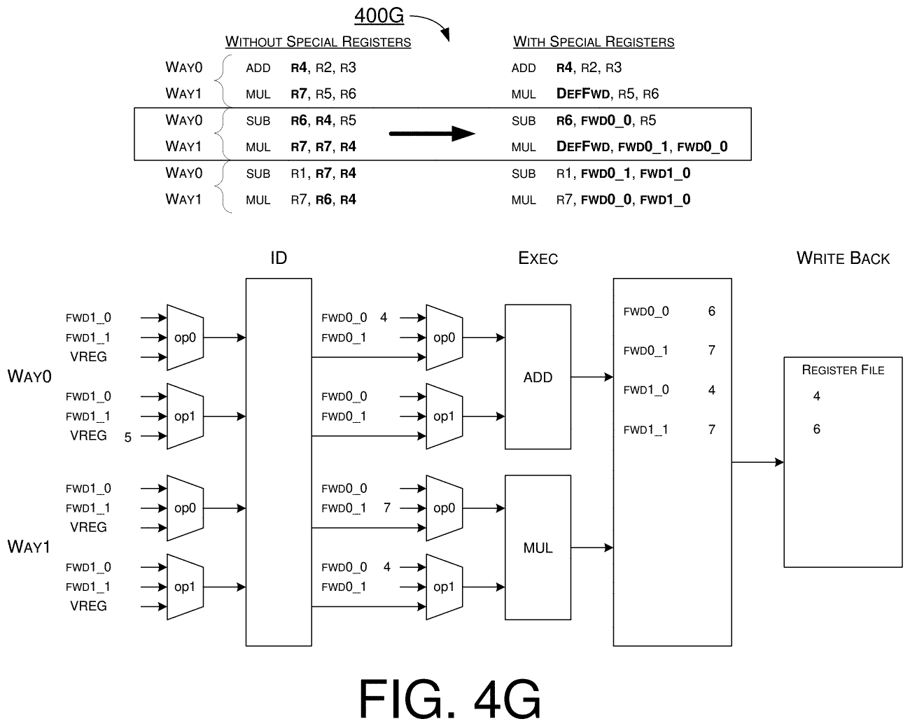

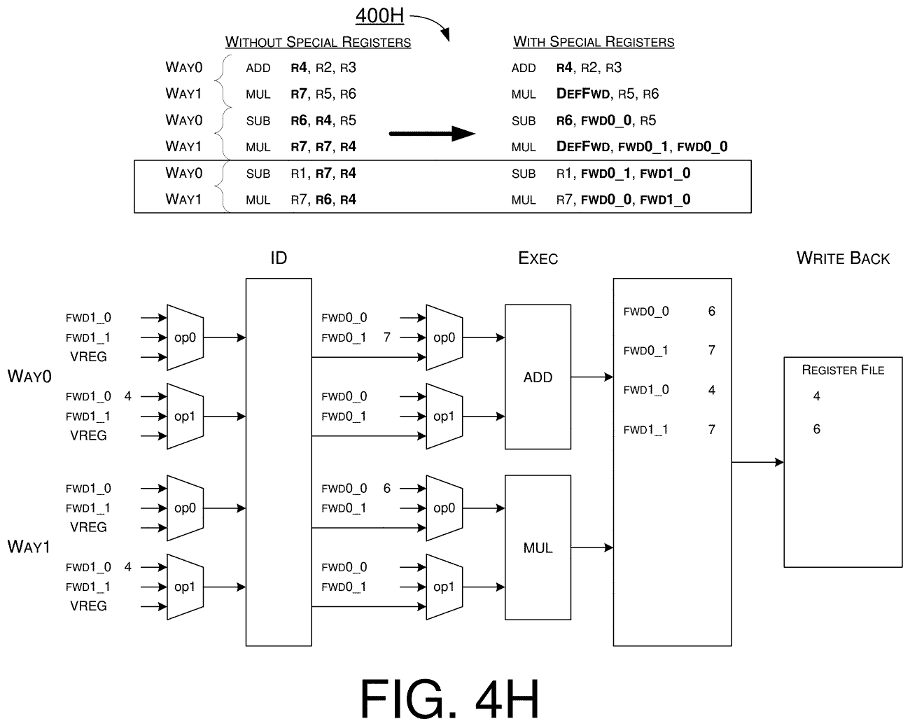

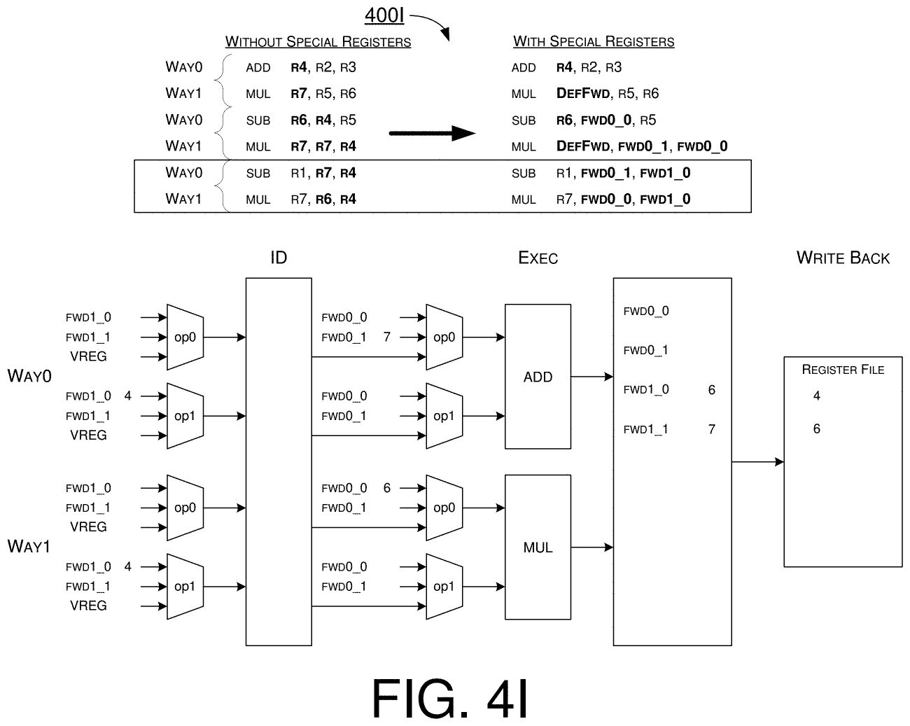

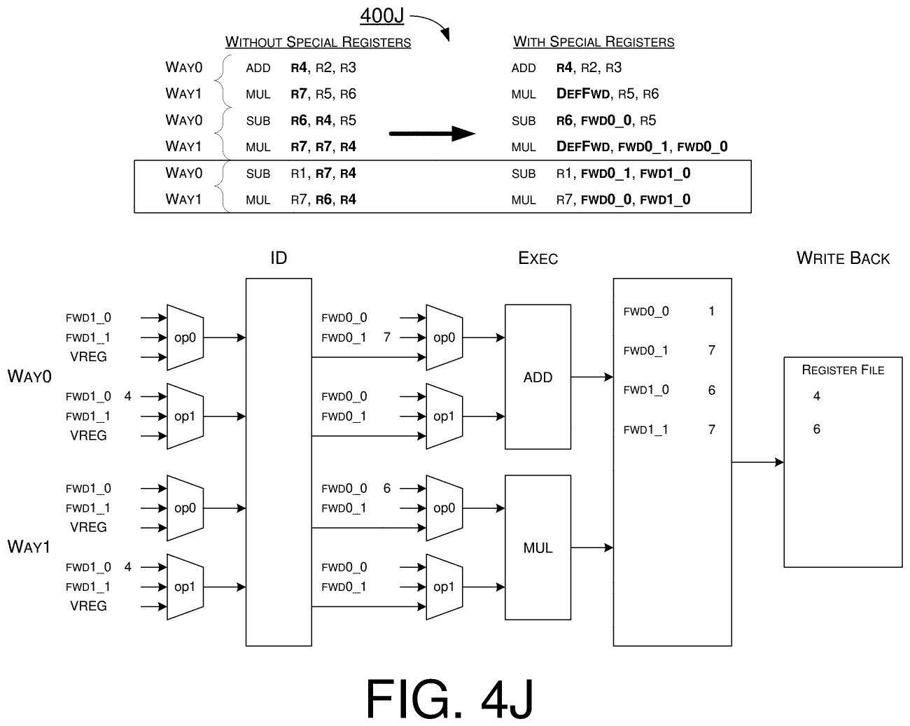

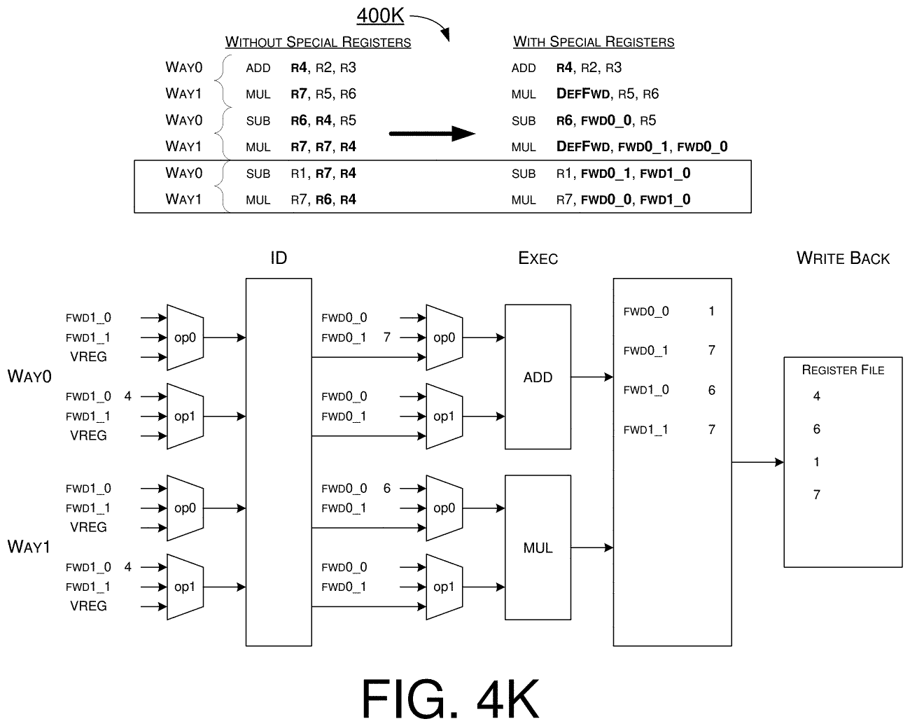

FIG. 4A-FIG. 4K each illustrates an example scenario 400A, 400B, 400C, 400D, 400E, 400F, 400G, 400H, 4001, 400J or 400K, respectively, in accordance with an implementation of the present disclosure. In particular, each of scenarios 400A, 400B, 400C, 400D, 400E, 400F, 400G, 400H, 400I, 400J and 400K depicts a step in performing the arithmetic operations shown in scenario 300B.

In scenario 400A, at a first stage in way 0, a value stored in register r2 (denoted by “2”) and a value stored in register r3 (denoted by “3”) are taken as input data from respective variable registers (each denoted by “VREG”) for the arithmetic operation of addition. Moreover, at a first stage in way 1, a value stored in register r5 (denoted by “5”) and a value stored in register r6 (denoted by “6”) are taken as input data from respective variable registers (each denoted by “VREG”) for the arithmetic operation of multiplication.

In scenario 400B, a value stored in register r4 (denoted by “4”) is stored in special register fwd0_0 for forwarding, and a value stored in register r7 (denoted by “7”) is stored in special register fwd0_1 for forwarding.

In scenario 400C, the value stored in special register fwd0_0 is also written into a register file (denoted by “4”) for write-back.

In scenario 400D, at the first stage in way 0, a value stored in register r5 (denoted by “5”) is taken as input data from a variable register (denoted by “VREG”) for the arithmetic operation of subtraction. Also, the value stored in special register fwd0_0 (denoted by “4”) is forwarded to a second stage in way 0 as input data for the arithmetic operation of subtraction. Similarly, the value stored in special register fwd0_0 (denoted by “4”) and special register fwd0_1 (denoted by “7”) are forwarded to the second stage in way 1 as input data for the arithmetic operation of multiplication.

In scenario 400E, the values stored in special register fwd0_0 is stored in special register fwd1_0 (denoted by “4”), and the values stored in special register fwd0_1 is stored in special register fwd1_1 (denoted by “7”).

In scenario 400F, the value stored in register r6 (denoted by “6”) is stored in special register fwd0_0 for forwarding, and the value stored in register r7 (denoted by “7”) is stored in special register fwd0_1 for forwarding.

In scenario 400G, the value stored in special register fwd0_0 is also written into the register file (denoted by “6”) for write-back.

In scenario 400H, at the first stage in way 0, the value stored in special register fwd1_0 (denoted by “4”) is taken as input data for the arithmetic operation of subtraction. Also, the value stored in special register fwd0_1 (denoted by “7”) is forwarded to the second stage in way 0 as input data for the arithmetic operation of subtraction. Similarly, at the first stage in way 1, the value stored in special register fwd1_0 (denoted by “4”) is taken as input data for the arithmetic operation of multiplication. Moreover, the value stored in special register fwd0_0 (denoted by “6”) is forwarded to the second stage in way 1 as input data for the arithmetic operation of multiplication.

In scenario 4001, the values stored in special registers fwd0_0 and fwd0_1 are removed, deleted or otherwise erased.

In scenario 400J, the value stored in register r1 (denoted by “1”) is stored in special register fwd0_0 for forwarding, and the value stored in register r7 (denoted by “7”) is stored in special register fwd0_1 for forwarding.

In scenario 400K, the value stored in special register fwd0_0 is also written into the register file (denoted by “1”) for write-back, and the value stored in special register fwd0_1 is also written into the register file (denoted by “7”) for write-back.

### Illustrative Implementations

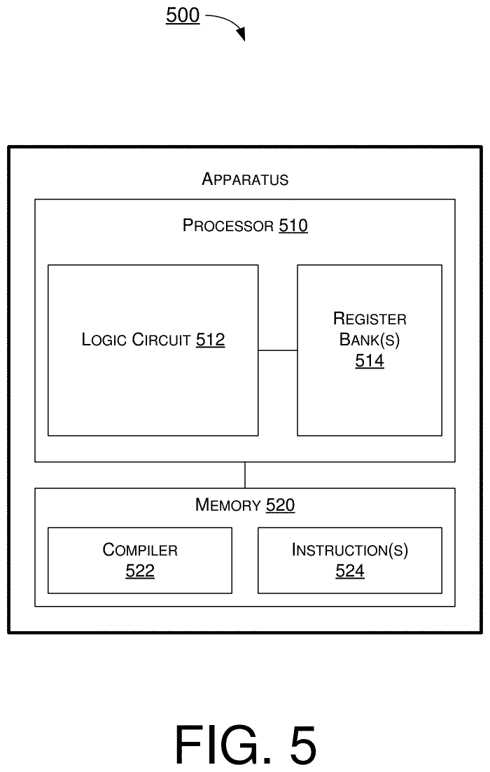

FIG. 5 illustrates an example apparatus 500 in accordance with an implementation of the present disclosure. Apparatus 500 may perform various functions to implement schemes, techniques, processes and methods described herein pertaining to compiler-allocated special registers that resolve data hazards with reduced hardware complexity, including the various schemes described above with respect to various proposed designs, concepts, schemes, systems and methods described above with respect to FIG. 1, FIG. 2, FIG. 3A, FIG. 3B and FIG. 4A - FIG. 4K as well as process 600 described below.

Apparatus 500 may be a user equipment (UE), such as a portable or mobile apparatus, a wearable apparatus, a wireless communication apparatus or a computing apparatus. For instance, apparatus 500 may be implemented in a smartphone, a smartwatch, a personal digital assistant, a digital camera, or a computing equipment such as a tablet computer, a laptop computer or a notebook computer. Apparatus 500 may also be a part of a machine type apparatus, which may be an internet-of-things (IoT) apparatus such as an immobile or a stationary apparatus, a home apparatus, a wire communication apparatus or a computing apparatus. For instance, apparatus 500 may be implemented in a smart thermostat, a smart fridge, a smart door lock, a wireless speaker or a home control center.

In some implementations, apparatus 500 may be implemented in the form of one or more integrated-circuit (IC) chips such as, for example and without limitation, one or more single-core processors, one or more multi-core processors, or one or more complex-instruction-set-computing (CISC) processors. Apparatus 500 may include at least some of those components shown in FIG. 5 such as a processor 510, for example. Apparatus 500 may further include one or more other components not pertinent to the proposed scheme of the present disclosure (e.g., power management circuitry), and, thus, such component(s) of apparatus 520 are neither shown in FIG. 5 nor described below in the interest of simplicity and brevity.

In one aspect, processor 510 may be implemented in the form of one or more single-core processors, one or more multi-core processors, or one or more CISC processors. That is, even though a singular term “a processor” is used herein to refer to processor 510, processor 510 may include multiple processors in some implementations and a single processor in other implementations in accordance with the present disclosure. In another aspect, processor 510 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 510 is a special-purpose machine specifically designed, arranged and configured to perform specific tasks including those pertaining to compiler-allocated special registers that resolve data hazards with reduced hardware complexity in accordance with various implementations of the present disclosure. In some implementations, processor 510 may include a logic circuit 512 and one or more register banks 514. Logic circuit 512 may include a plurality of hardware components such as, for example and without limitation, functional units, arithmetic logic units and multiplexers that are arranged in a VLIW architecture (e.g., such as that shown in FIG. 4A-FIG. 4K).

In some implementations, apparatus 500 may also include a memory 520 coupled to processor 510 and capable of being accessed by processor 510 and storing data therein. For instance, memory 520 may store a compiler program (shown as “compiler 522” in FIG. 5) as well as uncompiled and compiled instructions (shown as “instruction(s) 524” in FIG. 5) therein. Memory 520 may include a type of random-access memory (RAM) such as dynamic RAM (DRAM), static RAM (SRAM), thyristor RAM (T-RAM) and/or zero-capacitor RAM (Z-RAM). Alternatively, or additionally, memory 520 may include a type of read-only memory (ROM) such as mask ROM, programmable ROM (PROM), erasable programmable ROM (EPROM) and/or electrically erasable programmable ROM (EEPROM). Alternatively, or additionally, memory 520 may include a type of non-volatile random-access memory (NVRAM) such as flash memory, solid-state memory, ferroelectric RAM (FeRAM), magnetoresistive RAM (MRAM) and/or phase-change memory.

Under various schemes in accordance with the present disclosure, processor 510 may execute compiler 522 to perform a number of operations. For instance, processor 510 may allocate one or more forwarding registers (e.g., in register bank(s) 514) with respect to the execution of an instruction. Furthermore, processor 510 may perform arithmetic operations based on the instruction with data input from multiple ways of an instruction set architecture such that the one or more forwarding registers is utilized for data forwarding between the multiple ways of the instruction set architecture.

In some implementations, in performing the arithmetic operations, processor 510 may deliver forwarding information to one or more hardware components of the processor from different ways of the instruction set architecture through the one or more forward registers.

In some implementations, the delivering of the forwarding information to the one or more hardware components of the processor from the different ways of the instruction set architecture through the one or more forward registers may resolve data hazard between the different ways of the instruction set architecture.

In some implementations, the delivering of the forwarding information to the one or more hardware components of the processor from the different ways of the instruction set architecture through the one or more forward registers may eliminate a need to compare operands with forwarding results.

In some implementations, in delivering the forwarding information to the one or more hardware components of the processor from the different ways of the instruction set architecture through the one or more forward registers, processor 510 may deliver the forwarding information without additional encoding bit fields.

In some implementations, in delivering the forwarding information to the one or more hardware components of the processor from the different ways of the instruction set architecture through the one or more forward registers, processor 510 may maintain data in registers within two stages of pipeline without writing back to a register file.

In some implementations, in delivering the forwarding information to the one or more hardware components of the processor from the different ways of the instruction set architecture through the one or more forward registers, processor 510 may maintain data in registers within two stages of pipeline without writing to a next stage.

In some implementations, in allocating the one or more forwarding registers, processor 510 may allocate at least a first forwarding register and a second forwarding register. In such cases, the first forwarding register may be used for data forwarding for a first way of the instruction set architecture. Moreover, the second forwarding register may be used for data forwarding for a second way of the instruction set architecture. Additionally, the instruction set architecture may include a VLIW architecture. Moreover, in allocating the one or more forwarding registers, processor 510 may execute a compiler to provide the instruction for execution in the VLIW architecture.

In some implementations, in performing the arithmetic operations, logic circuit 512 of processor 510 may perform a number of operations. For instance, logic circuit 512 may perform a first operation on a first operand and a second operand to provide a first result which is stored in the first forwarding register. Additionally, logic circuit 512 may perform a second operation on a third operand and a fourth operand to provide a second result which is stored in the second forwarding register. Furthermore, logic circuit 512 may perform a third operation using the first result and the second result as operands to provide a third result by forwarding the first result and the second result to a functional unit that performs the third operation.

In some implementations, in allocating the one or more forwarding registers, processor 510 may allocate a deferred forwarding register which stores data that needs not be written to a register file. Illustrative Processes

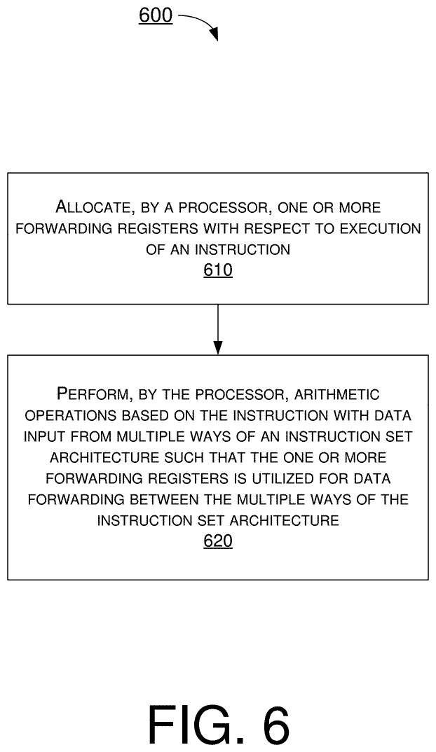

FIG. 6 illustrates an example process 600 in accordance with an implementation of the present disclosure. Process 600 may represent an aspect of implementing the proposed concepts and schemes pertaining to compiler-allocated special registers that resolve data hazards with reduced hardware complexity. Process 600 may be an example implementation, whether partially or entirely, of the concepts and schemes described above with respect to FIG. 1, FIG. 2, FIG. 3A, FIG. 3B, FIG. 4A-FIG. 4K, and FIG. 5. Process 600 may include one or more operations, actions, or functions as illustrated by one or more of blocks 610 and 620. Although illustrated as discrete blocks/sub-blocks, various blocks/sub-blocks of process 600 may be divided into additional blocks/sub-blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by apparatus 500 as well as any variations thereof. Solely for illustrative purposes and without limiting the scope, process 600 is described below in the context of apparatus 500. Process 600 may begin at block 610.

At 610, process 600 may involve processor 510 of apparatus 500 allocating one or more forwarding registers with respect to the execution of an instruction. Process 600 may proceed from 610 to 620.

At 620, process 600 may involve processor 510 performing arithmetic operations based on the instruction with data input from multiple ways of an instruction set architecture such that the one or more forwarding registers is utilized for data forwarding between the multiple ways of the instruction set architecture.

In some implementations, in performing the arithmetic operations, process 600 may involve processor 510 delivering forwarding information to one or more hardware components of the processor from different ways of the instruction set architecture through the one or more forward registers.

In some implementations, the delivering of the forwarding information to the one or more hardware components of the processor from the different ways of the instruction set architecture through the one or more forward registers may resolve data hazard between the different ways of the instruction set architecture.

In some implementations, the delivering of the forwarding information to the one or more hardware components of the processor from the different ways of the instruction set architecture through the one or more forward registers may eliminate a need to compare operands with forwarding results.

In some implementations, in delivering the forwarding information to the one or more hardware components of the processor from the different ways of the instruction set architecture through the one or more forward registers, process 600 may involve processor 510 delivering the forwarding information without additional encoding bit fields.

In some implementations, in delivering the forwarding information to the one or more hardware components of the processor from the different ways of the instruction set architecture through the one or more forward registers, process 600 may involve processor 510 maintaining data in registers within two stages of pipeline without writing back to a register file.

In some implementations, in delivering the forwarding information to the one or more hardware components of the processor from the different ways of the instruction set architecture through the one or more forward registers, process 600 may involve processor 510 maintaining data in registers within two stages of pipeline without writing to a next stage.

In some implementations, in allocating the one or more forwarding registers, process 600 may involve processor 510 allocating at least a first forwarding register and a second forwarding register. In such cases, the first forwarding register may be used for data forwarding for a first way of the instruction set architecture. Moreover, the second forwarding register may be used for data forwarding for a second way of the instruction set architecture. Additionally, the instruction set architecture may include a VLIW architecture. Moreover, in allocating the one or more forwarding registers, process 600 may involve processor 510 executing a compiler to provide the instruction for execution in the VLIW architecture.

In some implementations, in performing the arithmetic operations, process 600 may involve processor 510 performing a number of operations. For instance, process 600 may involve processor 510 performing a first operation on a first operand and a second operand to provide a first result which is stored in the first forwarding register. Additionally, process 600 may involve processor 510 performing a second operation on a third operand and a fourth operand to provide a second result which is stored in the second forwarding register. Furthermore, process 600 may involve processor 510 performing a third operation using the first result and the second result as operands to provide a third result by forwarding the first result and the second result to a functional unit that performs the third operation.

In some implementations, in allocating the one or more forwarding registers, process 600 may also involve processor 510 allocating a deferred forwarding register which stores data that needs not be written to a register file.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
allocating, by a processor, one or more forwarding registers with respect to execution of an instruction; and
performing, by the processor, arithmetic operations based on the instruction with data input from multiple ways of an instruction set architecture such that the one or more forwarding registers is utilized for data forwarding between the multiple ways of the instruction set architecture.

2. The method of claim 1, wherein the performing of the arithmetic operations comprises delivering forwarding information to one or more hardware components of the processor from different ways of the instruction set architecture through the one or more forward registers.

3. The method of claim 2, wherein the delivering of the forwarding information to the one or more hardware components of the processor from the different ways of the instruction set architecture through the one or more forward registers resolves data hazard between the different ways of the instruction set architecture.

4. The method of claim 2, wherein the delivering of the forwarding information to the one or more hardware components of the processor from the different ways of the instruction set architecture through the one or more forward registers eliminates a need to compare operands with forwarding results.

5. The method of claim 2, wherein the delivering of the forwarding information to the one or more hardware components of the processor from the different ways of the instruction set architecture through the one or more forward registers comprises delivering the forwarding information without additional encoding bit fields.

6. The method of claim 2, wherein the delivering of the forwarding information to the one or more hardware components of the processor from the different ways of the instruction set architecture through the one or more forward registers comprises maintaining data in registers within two stages of pipeline without writing back to a register file.

7. The method of claim 2, wherein the delivering of the forwarding information to the one or more hardware components of the processor from the different ways of the instruction set architecture through the one or more forward registers comprises maintaining data in registers within two stages of pipeline without writing to a next stage.

8. The method of claim 1, wherein the allocating of the one or more forwarding registers comprises allocating at least a first forwarding register and a second forwarding register, wherein the first forwarding register is used for data forwarding for a first way of the instruction set architecture, wherein the second forwarding register is used for data forwarding for a second way of the instruction set architecture, wherein the instruction set architecture comprises a very-long-instruction-word (VLIW) architecture, and wherein the allocating of the one or more forwarding registers comprises executing a compiler to provide the instruction for execution in the VLIW architecture.

9. The method of claim 8, wherein the performing of the arithmetic operations comprises:
performing a first operation on a first operand and a second operand to provide a first result which is stored in the first forwarding register;
performing a second operation on a third operand and a fourth operand to provide a second result which is stored in the second forwarding register; and
performing a third operation using the first result and the second result as operands to provide a third result by forwarding the first result and the second result to a functional unit that performs the third operation.

10. The method of claim 8, wherein the allocating of the one or more forwarding registers further comprises allocating a deferred forwarding register which stores data that needs not be written to a register file.

11. An apparatus, comprising:
a processor comprising a plurality of hardware components arranged in in an instruction set architecture, the processor capable of:
allocating one or more forwarding registers with respect to the execution of an instruction; and
performing arithmetic operations based on the instruction with data input from multiple ways of the instruction set architecture such that the one or more forwarding registers is utilized for data forwarding between the multiple ways of the instruction set architecture.

12. The apparatus of claim 11, wherein, in performing the arithmetic operations, the processor is capable of delivering forwarding information to one or more hardware components of the plurality of hardware components of the processor from different ways of the instruction set architecture through the one or more forward registers.

13. The apparatus of claim 12, wherein the delivering of the forwarding information to the one or more hardware components of the processor from the different ways of the instruction set architecture through the one or more forward registers resolves data hazard between the different ways of the instruction set architecture.

14. The apparatus of claim 12, wherein the delivering of the forwarding information to the one or more hardware components of the processor from the different ways of the instruction set architecture through the one or more forward registers eliminates a need to compare operands with forwarding results.

15. The apparatus of claim 12, wherein, in delivering the forwarding information to the one or more hardware components of the processor from the different ways of the instruction set architecture through the one or more forward registers, the processor is capable of delivering the forwarding information without additional encoding bit fields.

16. The apparatus of claim 12, wherein, in delivering the forwarding information to the one or more hardware components of the processor from the different ways of the instruction set architecture through the one or more forward registers, the processor is capable of maintaining data in registers within two stages of pipeline without writing back to a register file.

17. The apparatus of claim 12, wherein, in delivering the forwarding information to the one or more hardware components of the processor from the different ways of the instruction set architecture through the one or more forward registers, the processor is capable of maintaining data in registers within two stages of pipeline without writing to a next stage.

18. The apparatus of claim 11, wherein, in allocating the one or more forwarding registers, the processor is capable of allocating at least a first forwarding register and a second forwarding register, wherein the processor uses the first forwarding register for data forwarding for a first way of the instruction set architecture, wherein the processor uses the second forwarding register for data forwarding for a second way of the instruction set architecture, wherein the instruction set architecture comprises a very-long-instruction-word (VLIW) architecture, and wherein, in allocating the one or more forwarding registers, the processor executes a compiler to provide the instruction for execution in the VLIW architecture.

19. The apparatus of claim 18, wherein, in performing the arithmetic operations, the processor is capable of:
performing a first operation on a first operand and a second operand to provide a first result which is stored in the first forwarding register;
performing a second operation on a third operand and a fourth operand to provide a second result which is stored in the second forwarding register; and
performing a third operation using the first result and the second result as operands to provide a third result by forwarding the first result and the second result to a functional unit that performs the third operation.

20. The apparatus of claim 18, wherein, in allocating the one or more forwarding registers, the processor is further capable of allocating a deferred forwarding register which stores data that needs not be written to a register file.
